(19) United States
(12) Patent Application Publication
(10) Pub. No.: US 2023/0043542 A1
(43) Pub. Date: Feb. 9, 2023

(54) CHEST COMPRESSION MACHINE DRIVEN USING CHAIN DEVICE

(71) Applicant: ROBOTKISUL CO., LTD., Asan-si, Chungcheongnam-do (KR)

(72) Inventor: Jong Wook KIM, Anyang-si, Gyeonggi-do (KR)

(73) Assignee: ROBOTKISUL CO., LTD., Asan-si, Chungcheongnam-do (KR)

(21) Appl. No.: 17/782,345

(22) PCT Filed: Dec. 3, 2020
(86) PCT No.: PCT/KR2020/017580

§ 371 Date: Jul. 8, 2022

(30) Foreign Application Priority Data
Dec. 3, 2019 (KR) 10-2019-0159429
Dec. 3, 2020 (KR) 10-2020-0167879

(51) Int. Cl. A61H 31/00

(52) U.S. Cl. CPC A61H 31/006; A61H 31/005; A61H 2011/005

(57) ABSTRACT

A chest compressor for compressing a patient's chest to perform a cardio pulmonary resuscitation is provided. The chest compressor includes a housing, a driving module provided inside the housing, at least one chain device configured to be driven by the driving module, a guide member configured to guide a movement of the at least one chain device, and a pressing member provided in an end portion of the at least one chain device. The at least one chain device may be formed by connecting a plurality of chain members to each other in a longitudinal direction, and the pressing member may be configured to compress the patient's chest while moving up and down by the at least one chain device.

### TECHNICAL FIELD

The present disclosure relates to a chest compressor which performs cardio pulmonary resuscitation (CPR) on a patient in cardiac arrest, and more particularly, to a chest compressor configured to be driven using a chain device, have a low center of gravity, and improve use stability and convenience.

### BACKGROUND

Cardio Pulmonary Resuscitation (CPR) is an emergency treatment performed to restore a cardiorespiratory function of a patient with cardiac arrest or severe cardiorespiratory dysfunction and plays a very important role in protecting the patient with cardiac arrest from dying or undergoing serious brain damage.

CPR is performed while repeatedly compressing the patient's chest at an appropriate pressure at a rate of 120 to 140 times per minute. This makes it difficult for a rescue worker to manually perform CPR in a proper manner. In particular, when the surrounding environment is poor, for example, when the patient is being transported, there is a greater difficulty in performing CPR in a proper manner.

In order to solve such a matter, in recent years, a chest compressor which is capable of automatically performing CPR has been developed and used.

However, in a chest compressor used in the related art, a compressing rod is configured to be operated while reciprocating up and down by a piston or a ball screw. This causes a matter in that the chest compressor in the related art needs to be formed in a structure having a high height so as to be able to ensure sufficient the up-down movement of the compressing rod.

Such a high height may make the center of gravity of the chest compressor high. This makes it difficult to maintain the stable posture of the chest compressor, which may cause a matter such as hindering the field of view of the rescue worker.

In addition, when the chest compressor has the high center of gravity as described above, the chest compressor is prone to shaking during an operation so that the compression position may be changed. For this reason, there is a risk of causing matters such as a rupture of the liver or spleen, a fracture of the sternum, a fracture of the ribs, and a rupture of the heart due to the compression at such an inappropriate position.

### PRIOR ART DOCUMENT

Patent Document 1: Korean Registration Patent No. 10-1600404 (Feb. 29, 2016)

### SUMMARY

The present disclosure is made in view of the above matters in the related art, and the present disclosure is for the purpose of providing a chest compressor which is capable of being driven using a chain device to have a low center of gravity and improving use stability and convenience.

Representative configurations of the present disclosure to achieve the above-described aspects are described below.

According to an example embodiment of the present disclosure, there is provided a chest compressor for compressing a patient's chest to perform a cardio pulmonary resuscitation. The chest compressor according to an example embodiment of the present disclosure may include a housing, a driving module provided inside the housing, at least one chain device configured to be driven by the driving module, a guide member configured to guide a movement of the at least one chain device, and a pressing member provided in an end portion of the at least one chain device. According to an example embodiment of the present disclosure, the at least one chain device may be formed by connecting a plurality of chain members to each other in a longitudinal direction, and the pressing member may be configured to compress the patient's chest while moving up and down by the at least one chain device.

According to an example embodiment of the present disclosure, the chain device may include an inner chain part formed by connecting inner chain members to each other in a longitudinal direction; and an outer chain part formed by connecting outer chain members to each other in the longitudinal direction. The inner chain members may be configured such that a plurality of inner plates is arranged to be spaced apart from each other via bushing members, and the outer chain members may be configured such that a plurality of outer plates is arranged to be spaced apart from each other by connection pins.

According to an example embodiment of the present disclosure, each of the plurality of inner plates may include a first through-hole and a second through-hole which are arranged to be spaced apart from each other in the longitudinal direction, and each of the plurality of outer plates may include a first through-hole and a second through-hole which are arranged to be spaced apart from each other in the longitudinal direction. The first through-hole of each of the plurality of outer plates may be connected to the second through-hole of each of the plurality of inner plates by a respective connection pin of the connection pins, and the second through-hole of each of the plurality of outer plates may be connected to, by a respective connection pin of the connection pins, the first through-hole of another inner plate which is adjacent to the inner plate connected to the first through-hole of the outer plate.

According to an example embodiment of the present disclosure, each of the plurality of inner plates may include a linear portion formed on one side thereof to extend along the longitudinal direction, and each of the plurality of outer plates may include a linear portion formed on one side thereof to extend along the longitudinal direction.

According to an example embodiment of the present disclosure, the at least one chain device may include two chain devices arranged in two rows.

According to an example embodiment of the present disclosure, the chain devices arranged in the two rows may be configured such that one or more linear portions of the plurality of inner plates and one or more linear portions of the plurality of outer plates are brought into contact with each other.

According to an example embodiment of the present disclosure, the guide member may include a guide recess formed to guide the movement of the at least one chain device.

According to an example embodiment of the present disclosure, the guide recess may include a first guide recess formed to extend along a movement direction of the pressing member; and a second guide recess formed to extend in a direction different from the movement direction of the first guide recess.

According to an example embodiment of the present disclosure, the guide member may further include a guide protrusion formed to extend along the movement direction of the pressing member.

According to an example embodiment of the present disclosure, the guide protrusion may be inserted into a space between the bushing members in the chain devices arranged in the two rows.

According to an example embodiment of the present disclosure, the driving module may include a power generation part configured to generate a rotational driving force, a power transmission part configured to transmit the rotational driving force generated by the power generation part, and a chain driving part configured to move the at least one chain device with the rotational drive force transmitted from the power transmission part.

According to an example embodiment of the present disclosure, the chain driving part may include coupling protrusions formed on an outer circumferential surface of the chain driving part to protrude radially outward, and the coupling protrusions may be engaged with the bushing members of the at least one chain device to move the at least one chain device.

Further, the chest compressor according to the present disclosure may further include other additional configurations without departing from the technical sprit of the present disclosure.

A chest compressor according to an example embodiment of the present disclosure is configured to operate a pressing member using a chain device. Thus, it is possible to form the chest compressor in a compact structure having a relatively low center of gravity and further enhance the stability and convenience in use of the chest compressor.

### BRIEF DESCRIPTION OF THE FIGURES

FIG. 1 exemplarily illustrates an overall structure of a chest compressor according to an example embodiment of the present disclosure.

FIG. 2 exemplarily illustrates the overall structure of the chest compressor according to an example embodiment of the present disclosure (in which a mounting member is omitted).

FIG. 3 exemplarily illustrates an internal structure of the chest compressor according to an example embodiment of the present disclosure.

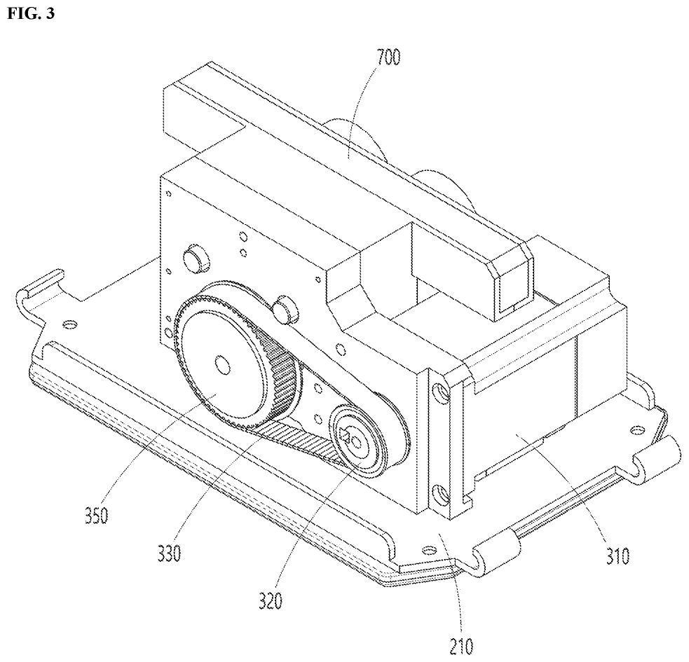

FIG. 4 exemplarily illustrates a structure in which a gear cover is omitted in FIG. 3.

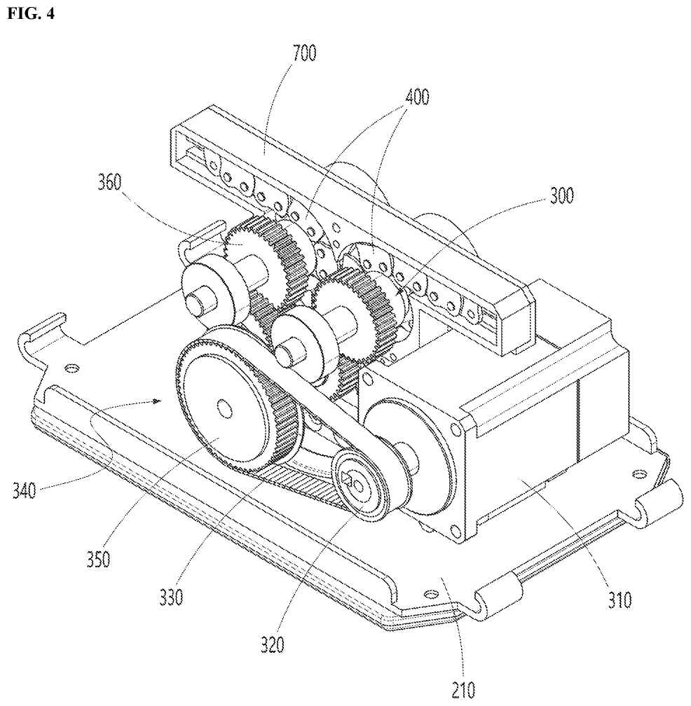

FIGS. 5A and 5B exemplarily illustrate an operation state of the chest compressor according to an example embodiment of the present disclosure, in which FIG. 5A illustrates a state before a pressing member is lowered and FIG. 5B illustrates a state in which the pressing member has been lowered.

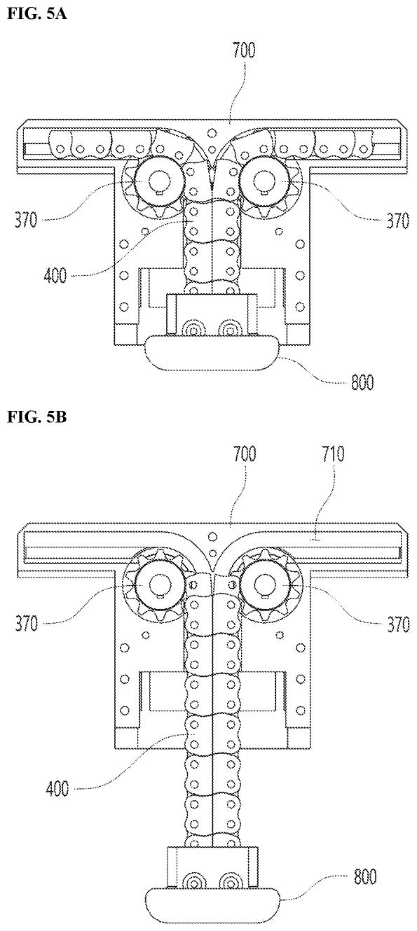

FIG. 6 exemplarily illustrates a structure of a guide member for guiding a movement of a chain device in the chest compressor according to an example embodiment of the present disclosure.

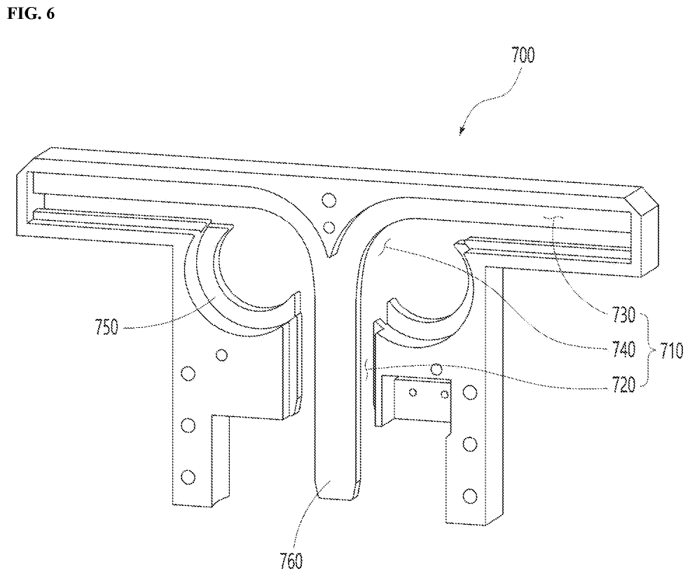

FIG. 7 exemplarily illustrates a structure of a chain driving part (sprocket member) that moves the chain device in the chest compressor according to an example embodiment of the present disclosure.

FIG. 8 exemplarily illustrates structures of the chain device and the pressing member coupled to the chain device in the chest compressor according to an example embodiment of the present disclosure.

FIGS. 9A and 9B exemplarily illustrate structures of an inner chain member (FIG. 9A) and an inner plate (FIG. 9B) of the chest compressor according to an example embodiment of the present disclosure.

FIGS. 10A and 10B exemplarily illustrate structures of an outer chain member (FIG. 10A) and an outer plate (FIG. 10B) of the chest compressor according to an example embodiment of the present disclosure.

FIG. 11 exemplarily illustrates the structure of the chain device of the chest compressor according to an example embodiment of the present disclosure.

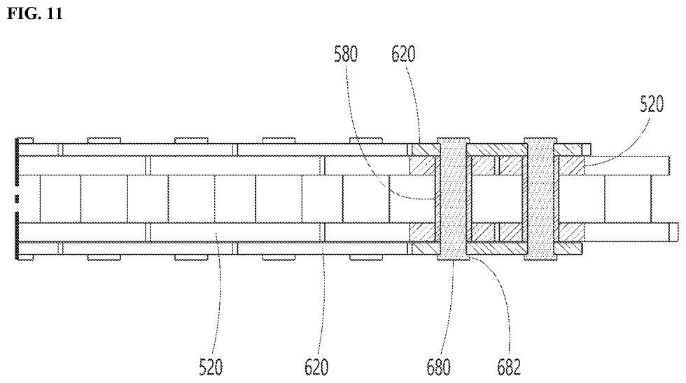

### EXPLANATION OF REFERENCE NUMERALS

100: Chest compressor

200: Housing

300: Driving module

400: Chain device

500: Inner chain part

510: Inner chain member

520: Inner plate

530: Through-hole (formed in inner plate)

540: Linear portion (formed on inner plate)

550: Curved portion (formed on inner plate)

560: Concave portion (formed on inner plate)

570: Convex portion (formed on inner plate)

580: Bushing member

600: Outer chain part

610: Outer chain member

620: Outer plate

630: Through-hole (formed in outer plate)

640: Linear portion (formed on outer plate)

650: Curved portion (formed on outer plate)

660: Concave portion (formed on outer plate)

670: Convex portion (formed on outer plate)

680: Connection pin

700: Guide member

710: Guide recess

720: First guide recess

730: Second guide recess

740: Curved portion

750: Sprocket recess

760: Guide protrusion

### DETAILED DESCRIPTION

Embodiments of the present disclosure are exemplified for the purpose of describing the technical spirit of the present disclosure. The scope of the claims according to the present disclosure is not limited to the embodiments described below or to the detailed descriptions of these embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other embodiments.

The singular form described herein may include the plural form unless the context clearly dictates otherwise, and this is equally applied to the singular form set forth in the claims.

As used herein, when a component is referred to as being “positioned” or “formed” to on one side of another component, the component may be directly positioned or formed to another component, or may be positioned or formed to another component by intervening yet another component therebetween.

The term “vertical direction” used herein means a direction in which a pressing member for compressing a patient's chest moves, the term “longitudinal direction” of a chain means a direction in which adjacent chain members are connected to each other (for example, the vertical direction in example embodiments described with reference to the figures), the term “widthwise direction” of the chain means a direction between plates on both sides that form the chain member.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the embodiments, duplicate descriptions of the same or corresponding components may be omitted. However, even though a description of a specific constituent element is omitted, such a constituent element is not intended to be excluded in any embodiment.

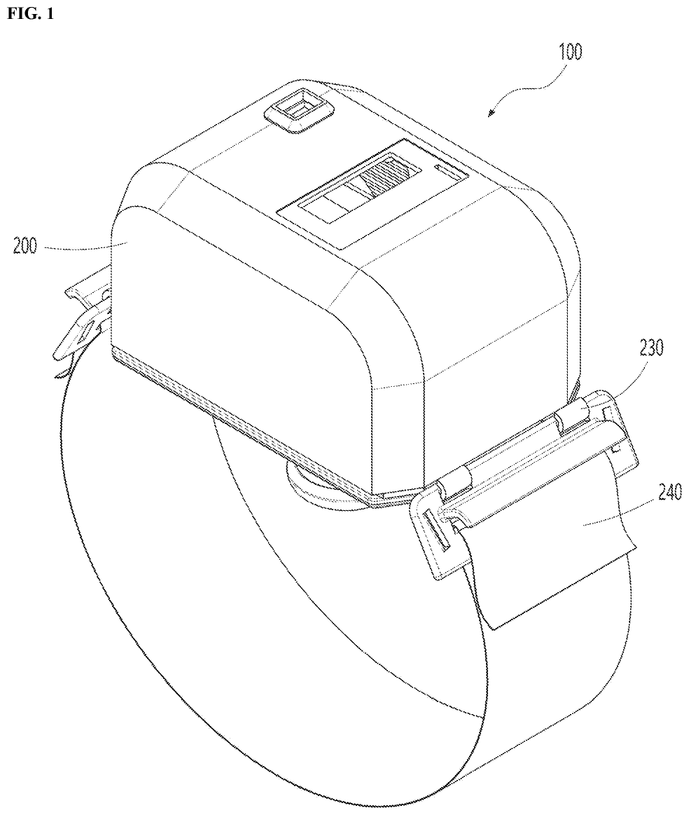

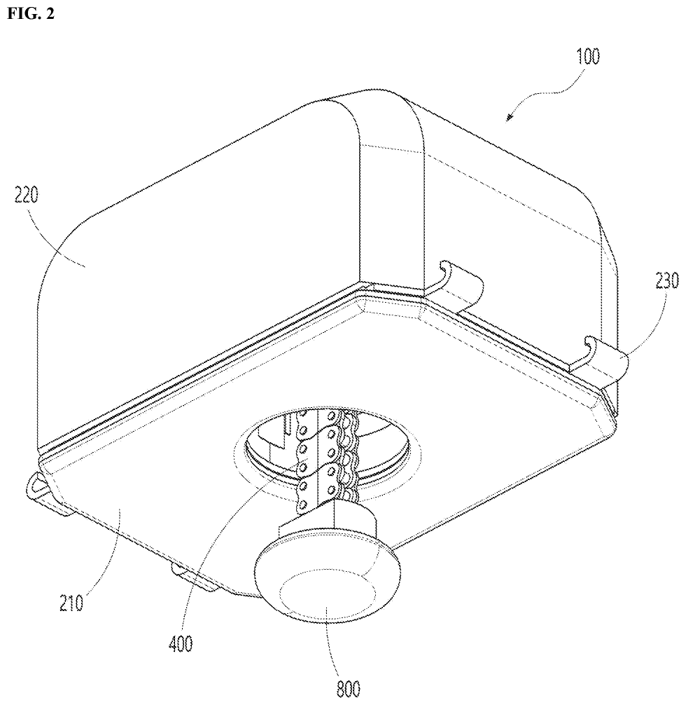

Referring to FIGS. 1 and 2, an overall structure of a chest compressor 100 according to an example embodiment of the present disclosure is exemplarily illustrated. As will be described below, the chest compressor 100 according to an example embodiment of the present disclosure has a feature in which a pressing member 800 is configured to be driven by at least one chain device 400.

According to an example embodiment of the present disclosure, the chest compressor 100 may be formed to have a structure in which a driving module 300, at least one chain device 400, a guide member 700 and the like are provided inside a housing 200. The pressing member 800 configured to press a patient's chest may be configured to be mounted and fixed to an end portion of the at least one chain device 400.

According to an example embodiment of the present disclosure, the housing 200, which is a part that defines an outer body of the chest compressor 100, may be formed by one or more members. For example, in a case of an example embodiment described with reference to the figures, the housing 200 is configured to be formed by a base member 210 and a cover member 220 coupled to an upper portion of the base member 210.

According to an example embodiment of the present disclosure, one side of the housing 200 may be provided with coupling parts 230. As illustrated in FIG. 1, a mounting member 240, such as a strap or the like, may be coupled to the chest compressor 100.

In the case of the example embodiment illustrated in FIG. 1, the mounting member 240 used to fix the chest compressor 100 is illustrated to be formed in a strap structure. However, the mounting member 240 is not limited thereto and may be formed in various structures as long as it may fix the chest compressor 100.

According to an example embodiment of the present disclosure, the driving module 300, which is a part configured to generate and transmit a driving force for operating the chest compressor 100, may be configured to include a power generation part 310, a power transmission part 340 and the like, similarly as in a driving device in the related art.

According to an example embodiment of the present disclosure, the power generation part 310, which is a part configured to generate a driving force for operating the chest compressor 100, may be configured with an electric motor or the like to generate a rotational driving force for moving the chain device 400 described below.

According to an example embodiment of the present disclosure, the power generation part 310 may be configured with an electric motor that generates a rotational driving force for bidirectionally reciprocating the pressing member 800 of the chest compressor 100 in the vertical direction.

According to an example embodiment of the present disclosure, the driving force generated by the power generation part 310 may be transmitted to the chain device 400 via the power transmission part 340. For example, an input-side pulley 320 may be provided in an output shaft of the power generation part 310 such that the driving force is transmitted to the power transmission part 340 via a pulley chain 330.

According to an example embodiment of the present disclosure, the power transmission part 340 may be configured to include an output-side pulley 350 to which the pulley chain 330 is connected, a plurality of connection gears 360 for decelerating and transmitting the rotational driving force transmitted from the power generation part 310, and the like.

According to an example embodiment of the present disclosure, the power transmission part 340 may be configured to include one or more chain driving parts 370 so as to move the chain device 400 described below by virtue of the driving force transmitted through the power transmission part 340.

For example, in a case of an example embodiment illustrated in the figure, two chain driving parts 3 70 are configured to be coupled to the power transmission part 340 to drive the chain device 400 having a two-row structure.

According to an example embodiment of the present disclosure, each of the chain driving parts 370 may be formed with a sprocket member that includes protrusions protruding radially outward.

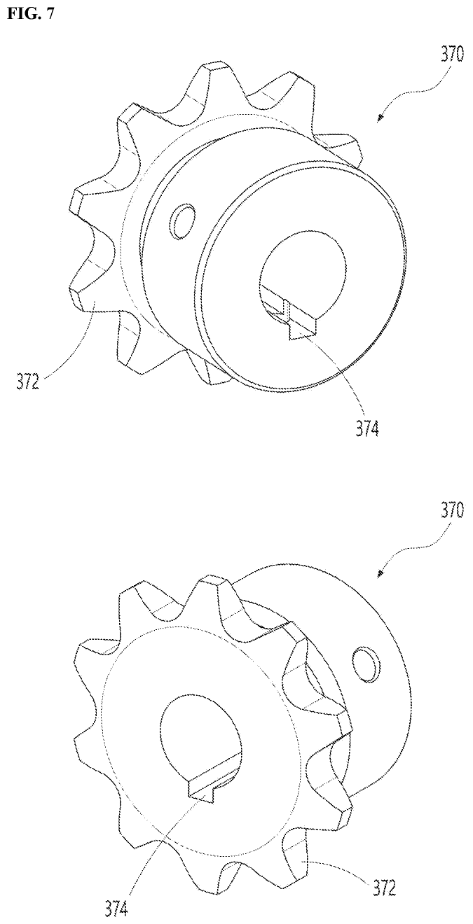

Specifically, according to an example embodiment of the present disclosure, as illustrated in FIG. 7, each of the chain driving parts 370 may include a plurality of coupling protrusions 372 formed to protrude radially outward while being spaced apart from each other along a circumferential direction on an outer circumferential surface of the chain driving part 370. The coupling protrusions 372 are inserted into the chain device 400 described below and engaged with bushing members 580 of the chain device 400 to move the chain device 400.

According to an example embodiment of the present disclosure, the chain driving part 370 may be configured to be coupled to a shaft of a connection gear 360 and rotate with the shaft. For example, in a case of an example embodiment illustrated in the drawings, a key groove 374 is formed in an inner circumferential surface of the chain driving part 370. A coupling protrusion (not illustrated) formed in an outer circumferential surface of the shaft is coupled to the key groove 374 so that the chain driving part 370 is configured to rotate with the shaft of the connection gear 360.

According to an example embodiment of the present disclosure, the chain device 400 may perform a function of repeatedly compressing the patient's chest with the pressing member 800 coupled to the end portion of the chain device 400 while reciprocating by the driving module 300.

According to an example embodiment of the present disclosure, the chain device 400 may be formed in one row or a plurality of rows. For example, in a case of an example embodiment illustrated in the drawings, the chain device 400 may be formed in two rows to more stably compress the patient's chest.

According to an example embodiment of the present disclosure, the chain device 400 may be configured such that a plurality of chain members is connected to each other in a continuous manner in the longitudinal direction.

According to an example embodiment of the present disclosure, the chain device 400 may be configured to include an inner chain part 500 positioned inward in the widthwise direction and an outer chain part 600 positioned outward in the widthwise direction. Each of the inner chain part 500 and the outer chain part 600 may be configured such that a plurality of chain members is connected to each other in a continuous manner in the longitudinal direction.

Specifically, according to an example embodiment of the present disclosure, the inner chain part 500 may be formed such that a plurality of inner chain members 510 are bendably connected to each other in the longitudinal direction.

According to an example embodiment of the present disclosure, the inner chain member 510 may be configured to include a plurality of inner plates 520 disposed to be spaced apart from each other and bushing members 580 connecting the plurality of inner plates 520.

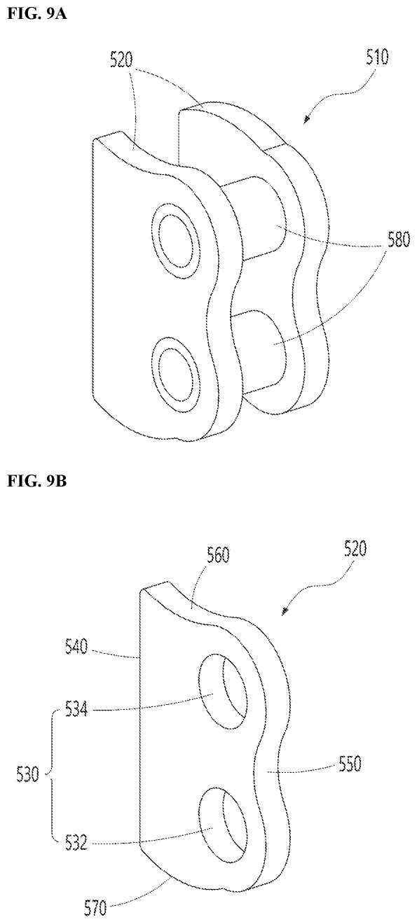

According to an example embodiment of the present disclosure, as illustrated in FIG. 9B, the inner plate 520 may be formed in a plate-like structure as a whole, and may include a plurality of through-holes 530 formed to be spaced apart from each other in the inner plate 520. For example, in a case of an example embodiment illustrated in the drawings, the inner plate 520 includes a first through-hole 532 and a second through-hole 534 which are spaced apart from each other in the longitudinal direction.

According to an example embodiment of the present disclosure, as illustrated in FIG. 9B, each inner plate 520 may include a linear portion 540 formed on one side thereof to extend in the longitudinal direction.

In the case in which the chain device 400 is provided in the two-row structure, as illustrated in the drawings, the chain devices 400 in the two rows are coupled to be brought into contact with each other via the linear portions 540. Thus, the linear portions 540 may be used to support the chain devices 400.

According to an example embodiment of the present disclosure, the inner plate 520 may include a curved portion 550 formed on a side facing the side of the inner plate 520 on which the linear portion 540 is formed. For example, as illustrated in FIGS. 9A and 9B, the curved portion 550 may be formed in a curved structure whose central portion is depressed inward.

According to an example embodiment of the present disclosure, a concave portion 560 may be formed on one side of the inner plate 520 in the longitudinal direction, and a convex portion 570 may be formed on the other side of the inner plate 520 in the longitudinal direction to have a shape corresponding to the concave portion 560. For example, the concave portion 560 and the convex portion 570 may allow adjacent inner chain parts 500 to be bendably connected to each other.

According to an example embodiment of the present disclosure, the bushing members 580, which connect the plurality of inner plates 520 arranged to be spaced apart from each other, may be formed in a structure in which central portion is opened. A through-hole formed in the central portion of each of the bushing members 580 may be in a coaxial relationship with the respective through-hole 530 formed in the inner plate 520.

According to an example embodiment of the present disclosure, the bushing member 580 may be formed of a member different from that of the inner plate 520 and may be configured to be coupled and fixed to the inner plate 520 (for example, coupled to the through-hole 530 of the inner plate 520 in a press-fitting manner). Alternatively, the bushing member 580 may be formed integrally with the inner plate 520.

According to an example embodiment of the present disclosure, the outer chain part 600 may be formed by connecting a plurality of outer chain members 610 to each other in a continuous manner along the longitudinal direction, similar to the inner chain part 500.

According to an example embodiment of the present disclosure, the outer chain part 600 may be configured to be formed by bendably connecting the plurality of outer chain members 610 to each other along the longitudinal direction, similar to the inner chain part 500 described above.

According to an example embodiment of the present disclosure, the outer chain member 610 may be configured to include a plurality of outer plates 620 arranged to be spaced apart from each other and connection pins 680 connecting the plurality of outer plates 620.

According to an example embodiment of the present disclosure, the outer plate 620 may be formed in substantially the same or similar structure as the inner plate 520 described above.

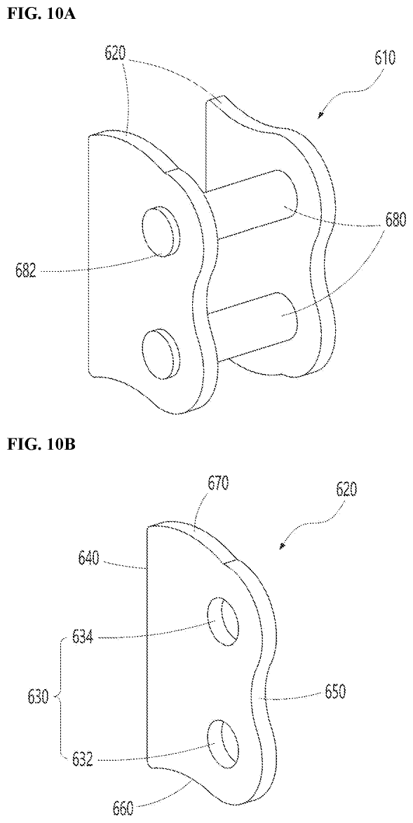

For example, according to an example embodiment of the present disclosure, as illustrated in FIG. 10B, the outer plate 620 may be formed in a plate-like structure as a whole, and may include a plurality of through-holes 630 formed to be spaced apart from each other in the outer plate 620. For example, in a case of an example embodiment illustrated in the drawings, the outer plate 620 includes a first through-hole 632 and a second through-hole 634 which are spaced apart from each other in the longitudinal direction.

According to an example embodiment of the present disclosure, as illustrated in FIG. 10B, each outer plate 620 may include a linear portion 640 formed on one side thereof to extend in the longitudinal direction. In the case in which the chain device 400 is provided in the two-row structure, as illustrated in the drawings, the chain devices 400 in the two rows are coupled to be brought into contact with each other via the linear portions 640. Thus, the linear portions 640 may be used to support the chain devices 400.

According to an example embodiment of the present disclosure, the outer plate 620 may include a curved portion 650 formed on a side facing the side of the outer plate 620 on which the linear portion 640 is formed.

According to an example embodiment of the present disclosure, a concave portion 660 may be formed on one side of the outer plate 620 in the longitudinal direction, and a convex portion 670 may be formed on the other side of the outer plate 620 in the longitudinal direction to have a shape corresponding to the concave portion 660.

According to an example embodiment of the present disclosure, the outer plate 620 may be configured to be positioned outward of the inner plate 520 described above in the widthwise direction. The outer plate 620 may be configured to be arranged in an alternate relationship with the inner plate 520, as illustrated in the drawings.

Specifically, the first through-hole 632 of one outer plate 620 may be aligned with the second through-hole 534 of one inner plate 520 so that the first through-hole 632 and the second through-hole 534 are connected to each other the respective connection pin 680. The second through-hole 634 of the one outer plate 620 may be aligned with the first through-hole 532 of another inner plate 520 which is adjacent to the one inner plate 520 connected to the outer plate 620 through the first through-hole 632 of the outer plate 620, so that the second through-hole 634 of the one outer plate 620 and the first through-hole 532 of another inner plate 520 are connected to each other the respective connection pin 680.

According to an example embodiment of the present disclosure, the outer chain member 610 may be configured to be rotatably connected to the inner chain member 510.

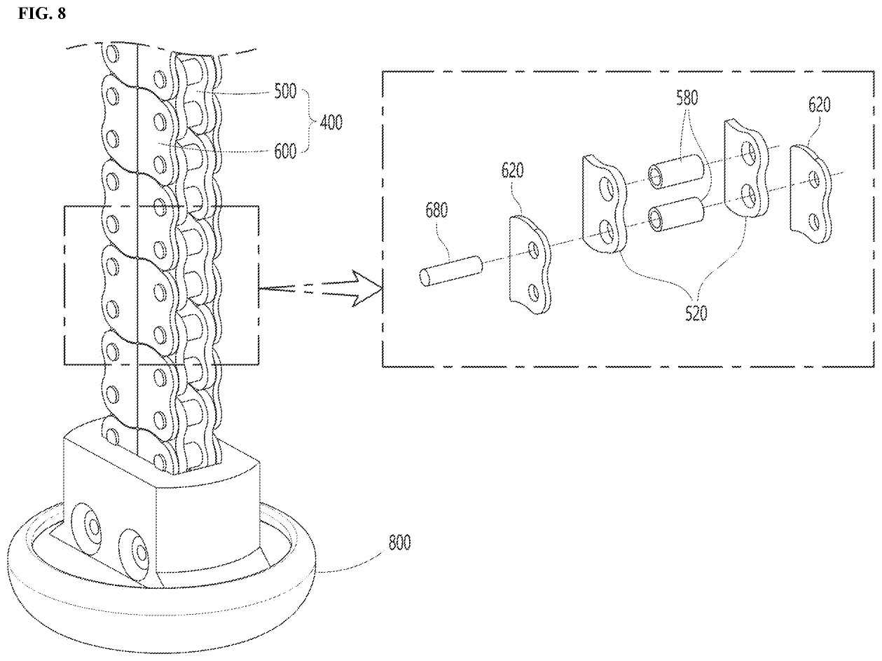

For example, as illustrated in FIG. 8, the outer chain member 610 may be configured to be rotatably mounted relative to the inner chain member 510 by positioning the outer plate 620 outward of the inner plate 520 in the widthwise direction, and inserting the respective connection pins 680 into the through-hole 630 of the outer plate 620, the through-hole 530 of the inner plate 520 and the through-holes of the bushing members 580.

Further, according to an example embodiment of the present disclosure, a flange portion 682 extending radially outward may be formed in each connection pin 680 protruding outward of the outer plate 620 in the widthwise direction. This configuration prevents separation of the outer plate 620.

According to an example embodiment of the present disclosure, the outer chain member 610 may be bendably coupled to the inner chain member 510 in one direction. For example, in a case of an example embodiment illustrated in the drawings, in a state in which the linear portions formed on one sides of the outer chain members 610 are arranged with respect to the inner chain members 510, the outer chain member 610 may not be bendable in a direction in which the linear portions are arranged, but may be bendable in a direction opposite to the direction.

According to an example embodiment of the present disclosure, the chain device 400 may be configured to be accommodated in the guide member 700 and move inside the guide member 700.

According to an example embodiment of the present disclosure, the guide member 700 may include a guide recess 710 in which the chain device 400 is accommodated. The guide recess 710 may be formed as a depressed groove, a hole or the like.

According to an example embodiment of the present disclosure, the guide recess 710 may be configured to include a first guide recess 720 formed to extend along a movement direction of the pressing member 800, and a second guide recess 730 formed to extend in a direction different from the extension direction of the first guide recess 720.

For example, in a case of an example embodiment illustrated in the drawings, the guide recess 710 may be formed in the guide member 700 such that the first guide recess 720 formed to extend in the movement direction of the pressing member 800 and the second guide recess 730 formed to extend in the direction perpendicular to the movement direction of the pressing member 800 are connected to each other via a curved portion 740.

However, in the chest compressor 100 according to an example embodiment of the present disclosure, the guide recess 710 is not limited to be formed in the above-described structure. The guide recess 710 may be formed in any other structure as long as it includes the first guide recess 720 that extends along the movement direction of the pressing member 800 and the second guide recess 730 that does not extend along the movement direction of the pressing member 800.

For example, the guide recess 710 may be configured to further include an additional guide recess formed to extend in another direction in addition to the first guide recess 720 and the second guide recess 730 illustrated in the drawings. Further, the second guide recess 730 may be formed in other shapes, such as a curved shape rather than the linear shape.

According to an example embodiment of the present disclosure, one side of the guide member 700 may be further provided with a sprocket recess 750 in which the chain driving part 370 is accommodated, a guide protrusion 760 extending along the movement direction of the pressing member 800, and the like.

According to an example embodiment of the present disclosure, as illustrated in the drawings, in the chain device 400 arranged in two rows, the guide protrusion 760 may be configured to be coupled to the chain device 400 while being inserted into a space between the bushing members 580 in the two rows. Thus, the guide protrusion 760 may perform a function of more stably guiding the movement of the chain device 400 and the pressing member 800 coupled thereto.

According to an example embodiment of the present disclosure, the pressing member 800 may be fixed to the end portion of the chain device 400 to perform the function of repeatedly compressing the patient's chest while moving up and down with the driving of the chain device 400.

According to an example embodiment of the present disclosure, the pressing member 800 may be configured such that a bottom surface thereof is formed in a substantially flat shape to compress the patient's chest in a stable manner.

The chest compressor 100 according to the above-described example embodiments of the present disclosure is configured such that the pressing member 800 for compressing the patient's chest is connected to the chain device 400 and is driven by the chain device 400, and the chain device 400 is formed in a bendable structure in one direction and moves along the guide recess 710 formed in the guide member 700. Further, the chest compressor 100 according to the above-described example embodiments of the present disclosure is configured to be accommodated in the housing while moving in a direction (for example, a lateral direction) different from the movement direction of the pressing member 800. This configuration makes it possible to manufacture the chest compressor 100 in a compact structure having a relatively low height, which lowers the center of gravity of the chest compressor 100 and thus improves structural stability of the chest compressor 100.

Although the present disclosure has been described above in terms of specific items such as detailed constituent elements as well as the limited embodiments, they are merely provided to help more general understanding of the present disclosure, and the present disclosure is not limited to the above embodiments. Various modifications and changes could have been realized by those skilled in the art to which the present disclosure pertains from the above description.

Therefore, the spirit of the present disclosure need not to be limited to the above-described embodiments, and in addition to the appended claims to be described below, and all ranges equivalent to or changed from these claims need to be the to belong to the scope and spirit of the present disclosure.

1. A chest compressor for compressing a patient's chest to perform a cardio pulmonary resuscitation, the chest compressor comprising:
a housing;
a driving module provided inside the housing;
at least one chain deviceconfigured to be driven by the driving module;
a guide member configured to guide a movement of the at least one chain device; and
a pressing member provided in an end portion of the at least one chain device,
wherein the at least one chain device is formed by connecting a plurality of chain members to each other in a longitudinal direction, and
the pressing member is configured to compress the patient's chest while moving up and down by the at least one chain device.

2. The chest compressor of claim 1, wherein the chain device includes:
an inner chain part formed by connecting inner chain members to each other in a longitudinal direction; and
an outer chain part formed by connecting outer chain members to each other in the longitudinal direction,
wherein the inner chain members are configured such that a plurality of inner plates are arranged to be spaced apart from each other via bushing members, and
the outer chain members are configured such that a plurality of outer plates are arranged to be spaced apart from each other by connection pins.

3. The chest compressor of claim 2, wherein each of the plurality of inner plates includes a first through-hole and a second through-hole which are arranged to be spaced apart from each other in the longitudinal direction, and each of the plurality of outer plates includes a first through-hole and a second through-hole which are arranged to be spaced apart from each other in the longitudinal direction, wherein the first through-hole of each of the plurality of outer plates is connected to the second through-hole of each of the plurality of inner plates by a respective connection pin of the connection pins, and the second through-hole of each of the plurality of outer plates is connected to, by a respective connection pin of the connection pins, the first through-hole of another inner plate which is adjacent to the inner plate connected to the first through-hole of the outer plate.

4. The chest compressor of claim 3, wherein each of the plurality of inner plates includes a linear portion formed on one side thereof to extend along the longitudinal direction, and each of the plurality of outer plates includes a linear portion formed on one side thereof to extend along the longitudinal direction.

5. The chest compressor of claim 4, wherein the at least one chain device includes two chain devices arranged in two rows.

6. The chest compressor of claim 5, wherein the chain devices arranged in the two rows are configured such that one or more linear portions of the plurality of inner plates and one or more linear portions of the plurality of outer plates are brought into contact with each other.

7. The chest compressor of claim 3, wherein the guide member includes a guide recess formed to guide the movement of the at least one chain device.

8. The chest compressor of claim 7, wherein the guide recess includes:
a first guide recess formed to extend along a movement direction of the pressing member; and
a second guide recess formed to extend in a direction different from the movement direction of the first guide recess.

9. The chest compressor of claim 8, wherein the guide member further includes a guide protrusion formed to extend along the movement direction of the pressing member.

10. The chest compressor of claim 9, wherein the guide protrusion is inserted into a space between the bushing members in the chain devices arranged in the two rows.

11. The chest compressor of claim 10, wherein the driving module includes:
a power generation part configured to generate a rotational driving force;
a power transmission part configured to transmit the rotational driving force generated by the power generation part; and
a chain driving part configured to move the at least one chain device with the rotational drive force transmitted from the power transmission part.

12. The chest compressor of claim 11, wherein the chain driving part includes coupling protrusions formed on an outer circumferential surface of the chain driving part to protrude radially outward, and
the coupling protrusions are engaged with the bushing members of the at least one chain device to move the at least one chain device.
